(19) United States
(12) Patent Application Publication
(10) Pub. No.: US 2013/0175412 A1
(43) Pub. Date: Jul. 11, 2013

(54) STAND FOR HOLDING AT LEAST ONE MEDICAL DEVICE, IN PARTICULAR A MICROSCOPE

(71) Applicant: Leica Microsystems (Schweiz) AG, Heerbrugg (CH)

(72) Inventor: Marco Schutz, Rorschach (CH)

(73) Assignee: LEICA MICROSYSTEMS (SCHWEIZ) AG, Heerbrugg (CH)

(21) Appl. No.: 13/736,666

(22) Filed: Jan. 8, 2013

(30) Foreign Application Priority Data
Jan. 11, 2012 (DE) 10 2012 100 179.0

(51) Int. Cl. G02B 21/24

(52) U.S. Cl. CPC G02B 21/24
USPC 248/123.2

(57) ABSTRACT

A stand (10, 100) for holding a medical device (W1, W2, W3) includes a stand foot (9) and a carrier unit (1) connected to the stand foot rotatably about an axis (S), the medical device being mountable on the carrier unit. The stand also includes a counterweight (W4) to compensate for the torque about the axis produced by the medical device and the carrier unit, a first receiving unit (6, 102) at a first location for receiving at least a portion of the counterweight, and a second receiving unit (7, 104) at a second location for receiving at least another portion of the counterweight. Upon a change in torque about the axis, a proportion of the counterweight received by the first receiving unit is increasable by a compensation value, and that proportion of the counterweight which is received by the second receiving unit is reducible by that compensation value.

### CROSS REFERENCE TO RELATED APPLICATIONS

This application claims priority of German patent application number 10 2012 100 179.0 filed Jan. 11, 2012, the entire disclosure of which is incorporated by reference herein.

### FIELD OF THE INVENTION

The invention relates to a stand, for holding at least one medical device, which encompasses a stand foot and a carrier unit connected to said stand foot rotatably about an axis, the medical device being mountable on the carrier unit.

The stand is used in particular for holding microscopes and optionally further add-on devices, for example illumination systems, in the context of a surgical procedure. What is achieved with the carrier unit is that the microscope can be brought into the optimal position for the surgical procedure in simple fashion, with no need for the stand itself to be moved. The rotational torque acting about the axis changes as a result of the movement of the microscope and/or the addition and/or removal of further medical devices, so that it is necessary to compensate for that torque in order for the microscope and the further medical devices to remain in their positions without requiring a surgeon to apply energy for that purpose.

### BACKGROUND OF THE INVENTION

The documents EP 1 915 965 A2, US 5,528,417 A, and US 6,050,530 A each disclose stands in which the microscope is connected to the stand foot via multiple vertical and multiple horizontal carriers. The horizontal and the vertical carriers are each connected via multiple rotation points and corresponding connection elements, thereby constituting two parallelograms. Arranged in the region of the stand foot are one or two counterweights, which each are arranged on the carrier unit displaceably in one direction and by which the torque generated by the microscope is compensated for.

With these known apparatuses, it is problematic that the displacement travel within which the counterweight or counterweights can be displaced is quite limited, so that it is often necessary for the counterweights to be replaced. This involves considerable complexity and thus a low level of operating convenience. It is further necessary for multiple different counterweights to be kept in stock for this purpose, entailing a corresponding space requirement. Such counterweights can furthermore easily be misplaced.

### SUMMARY OF THE INVENTION

It is an object of the invention to describe a stand, for holding at least one medical device, with the aid of which it is possible in simple fashion to arrange the medical device in different positions.

This object is achieved by a stand having the features and advantageous refinements described herein.

According to the present invention, a counterweight is provided in order to compensate for the rotational torque about the axis produced by the medical device and the carrier unit, a first receiving unit for receiving at least a portion of the counterweight being provided at a first location, and a second receiving unit for receiving at least a portion of the counterweight being provided at a second location. As the torque around the axis produced by the medical device and the carrier unit changes, in order to compensate for the torque, that proportion of the counterweight which is received in the first receiving unit is increasable by a compensation value, and that proportion of the counterweight which is received in the second receiving unit is reducible by that compensation value.

As a result of the increase in the mass received in the first receiving unit, and the reduction in the mass received in the second receiving unit, by the corresponding value, the rotational torque about the axis is correspondingly modified. In this context, it is modified in particular in such a way that the counter-torque that is generated compensates for the torque about the axis produced by the medical device or devices, so that the apparatus is equilibrated and the medical device thus remains in the desired position.

Equilibration thus occurs not by displacing a counterweight or by adding or removing a counterweight, but instead by transferring a portion of the counterweight from the second to the first receiving unit. Particularly simple and convenient handling in the context of equilibration is thus possible, and misplacement of the counterweight is avoided.

It is furthermore advantageous if that proportion of the counterweight which is removed from the second receiving unit is conveyable to the first receiving unit. The first and the second receiving unit are, in particular, connected to one another via a connection unit. By way of this connection unit, the portion removed from the second receiving unit is conveyed in particular to the first receiving unit. Alternatively, a portion of the counterweight can also remain in the connection unit; upon equilibration, that exact portion of the counterweight which is removed from the second receiving unit is then not conveyed to the first receiving unit, but instead a portion of that portion of the counterweight which is received in the connection unit is conveyed to the first receiving unit, and a portion of that portion of the counterweight which is removed from the second counterweight remains in the connection unit.

It is furthermore advantageous if, upon a change in the torque about the axis produced by the medical device and/or the carrier unit, in order to compensate for the torque, that proportion of the counterweight which is received in the second receiving unit is increasable by a compensation value, or that proportion of the counterweight which is received in the first receiving unit is reducible by that compensation value. The result of this is that the counterweight, or portions of the counterweight, can be shifted in both directions between the two receiving units, so that any desired compensation is possible.

The distribution of the counterweight between the first receiving unit and the second receiving unit is, in particular, steplessly modifiable, so that the most accurate possible compensation for the torque generated by the medical device is possible, and simple equilibration of the stand is achieved.

It is particularly advantageous if both the first receiving unit and the second receiving unit are embodied in such a way that the entire counterweight is receivable in it. A particularly good adjustment capability is thereby achieved. Alternatively, one of the two receiving units, or both receiving units, can also be embodied in such a way that the entire counterweight is not receivable in it. In this case a portion of the counterweight always remains in the other receiving unit.

The distance of the first location from the axis and the distance of the second location from the axis are, in particular, different, thus resulting in different lever arms. It is particularly advantageous if the second receiving unit is arranged and embodied in such a way that the axis extends through the center point of the second receiving unit. No torque about the axis is generated by that portion of the counterweight which is received in the second receiving unit, so that the counter-torque in order to compensate for the torque generated by the medical device is generated exclusively by that proportion of the counterweight which is received in the first receiving unit, or by a proportion of the counterweight which is received in a connection unit that may be present.

In a particularly preferred embodiment, the counterweight is embodied as a liquid. In this case the first receiving unit encompasses a first container for receiving at least a portion of the liquid, and the second receiving unit correspondingly encompasses a second container for receiving at least a portion of the liquid. The first and the second container are interconnected via at least one conduit for the passage of liquid. In order to compensate for the torque generated about the axis for the medical device and the carrier unit, the liquid is transported via the conduit between the two containers in such a way that the counter-torque generated by the liquid compensates for the torque generated by the carrier unit and the medical device. A liquid makes possible stepless and simple adjustment of the counter-torque, thus making possible particularly simple handling.

A pump, in particular, can be provided for delivering liquid between the two containers. This pump can be driven manually and/or electrically.

In an alternative embodiment of the invention, the counterweight encompasses a spoolable element. The spoolable element can be, in particular, a chain, a belt, and/or a cable. The first receiving unit encompasses a first reel and the second receiving unit encompasses a second reel, a first end region of the spoolable element being mounted on the first reel and a second end region, located oppositely from the first end region, of the spoolable element being mounted on the second reel. In order to compensate for the medical device and the torque moving the carrier unit about the axis, a portion of the spoolable element is unwound from the one reel and wound onto the other reel. That portion of the counterweight which is wound onto the two reels is thereby modified, so that the counter-torque is modified and the stand is equilibrated.

A drive unit, in particular, is provided for rotating the first reel and/or for rotating the second reel in order to wind on and unwind the spoolable element. This drive unit preferably encompasses an electric motor. Additionally or alternatively, a hand crank can also be provided for rotating the reels.

The sum of the mass received in the first receiving unit and the mass received in the second receiving unit is, in particular, constant.

The carrier unit encompasses in particular a vertically oriented first parallel member and a horizontally oriented second parallel member, the two parallel members being respectively embodied in particular in the form of a parallelogram. Simple equilibration is thereby made possible.

The first parallel member is, in particular, connected to the stand foot via a monovalent joint. Arranged at that end region of the second parallel member which is located oppositely from the first end region is, in particular, a carrier unit on which the at least one medical device can in turn be arranged. This carrier unit is connected, in particular, articulatedly to the second parallel member, yielding the greatest possible freedom of movement for the medical device.

The medical device is, in particular, a microscope. In addition, further auxiliary apparatuses can also be attached to the carrier unit. These are, for example, illumination systems.

A further aspect of the invention relates to an arrangement that encompasses an above-described stand and at least one medical device attached to the carrier unit. The medical device is, in particular, a microscope.

### BRIEF DESCRIPTION OF THE DRAWING VIEWS

Further features and advantages of the invention are evident from the description that follows, which further explains the invention on the basis of exemplifying embodiments in connection with the appended Figures, in which:

FIG. 1 schematically depicts a stand for holding a microscope, in accordance with a first embodiment; and

FIG. 2 schematically depicts a stand for holding a microscope, in accordance with the second embodiment.

### DETAILED DESCRIPTION OF THE INVENTION

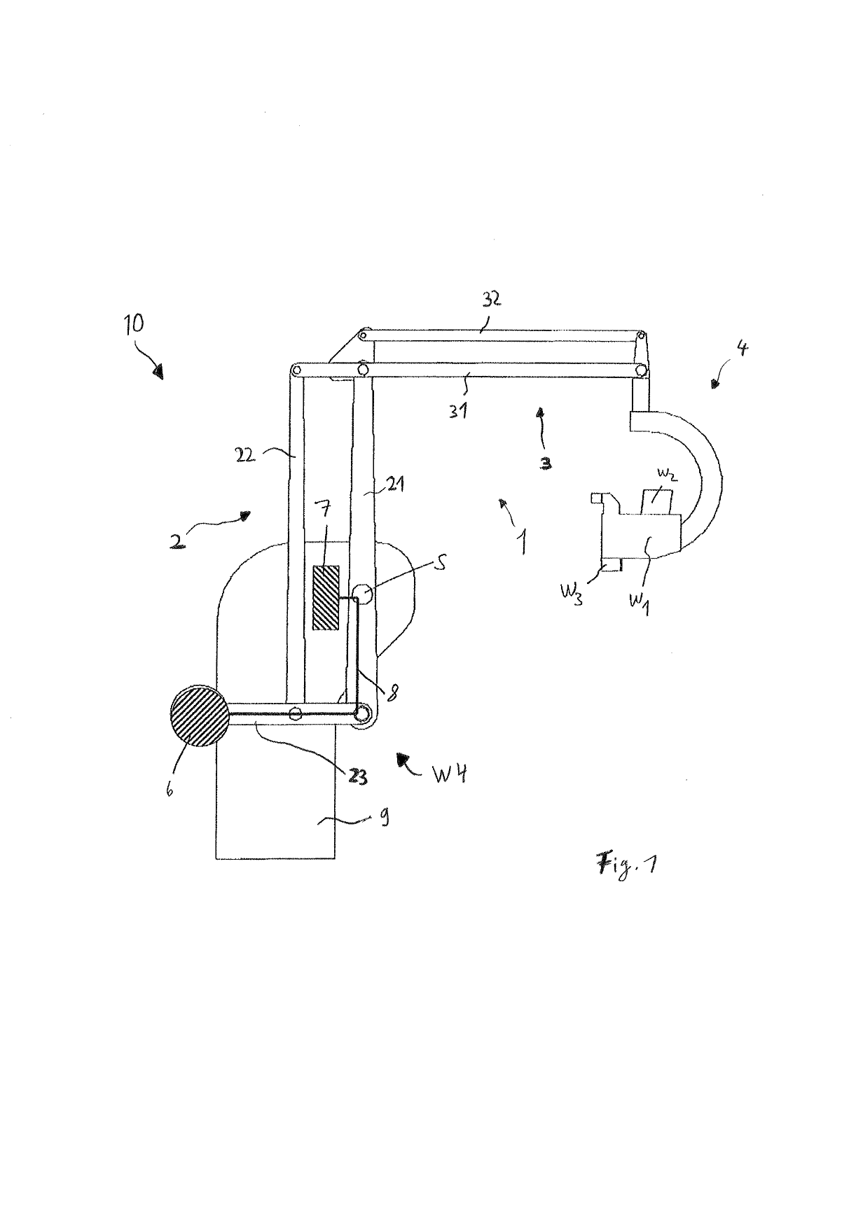

FIG. 1 schematically depicts a stand 10 for holding a microscope W1, in accordance with a first embodiment. Stand 10 is used in particular in operating rooms in order to hold microscope W1, so that the surgeon's hands are free for the surgical procedure and he or she is not impeded by microscope W1. Stand 10 encompasses a carrier unit 1 mounted on a stand foot 9 rotatably about an axis S, on which stand microscope W1 is in turn mounted. Stand foot 9 serves for placement of stand 10 on the floor. Carrier unit 1 encompasses a first parallel member 2 and a second parallel member 3 connected articulatedly to the first parallel member. First parallel member 2 encompasses two carriers 21 and 22, extending parallel to one another, that are oriented substantially vertically. Second parallel member 3 encompasses two carriers 31, 32 extending substantially horizontally. Carriers 21, 22, 31, 32 are interconnected via multiple joints and connecting elements so as to constitute two parallelograms, a first end region of first parallel member 2 and a first end region of second parallel member 3 being interconnected. Arranged at the second end region, located oppositely from the first end region, of second parallel member 3 is a holding unit 4 that is connected to second parallel member 3 in particular via a joint, and on which microscope W1 is mounted.

In the exemplifying embodiment shown in FIG. 1, two further auxiliary apparatuses W2, W3 are also mounted on holding unit 4 in addition to microscope W1. These can be, for example, illumination systems.

Depending on which auxiliary apparatuses W2, W3 are arranged on holding unit 4, and depending on the position in which microscope W1, and correspondingly auxiliary apparatus W2, W3, are arranged, the torque about axis S generated by them and by carrier unit 1 is different. In order for microscope W1, and auxiliary apparatuses W2, W3 that may be present, to remain in the desired position, there is provided at the second end region, located oppositely from the first end region, of second parallel member 2 a counterweight W4 by which a counter-torque is generated so as to compensate for the torque about axis S generated for microscope Wl, auxiliary apparatus W2, W3, and carrier unit 1, so that stand 10 is equilibrated and microscope W1 remains in the desired position with no expenditure of energy.

Counterweight W4 is embodied in the form of a liquid, for example water. Two receiving units 6, 7, embodied as containers, are connected for this purpose at different locations to carrier unit 1. Receiving units 6, 7 are interconnected via a conduit 8 in such a way that the liquid can be moved via this conduit 8 between the two receiving units 6, 7. First receiving unit 6 is arranged at a first location, and second receiving unit 7 at a second location, the distances of the two locations from axis S being different so that the respective lever arm is different and so that a different counter-torque is generated about axis S depending on what proportions of counterweight W4, i.e. what proportions of the liquid, are received in each of the two receiving units 6, 7. First receiving unit 6 is arranged in particular at the second end region, located oppositely from the first end region, of first parallel member 2, in particular on a horizontally extending carrier 23, so that the lever arm with respect to axis S is comparatively long. Second receiving unit 7, conversely, is arranged as close as possible to axis S, so that the lever arm is correspondingly short. The result of this is that only a little liquid needs to be shifted between the two receiving units 6, 7 in order to produce a large change in counter-torque.

Receiving units 6, 7 are embodied in particular in such a way that the entirety of liquid W4 can be received in each of them, so that a large change in counter-torque is possible with as little liquid as possible.

A pump (not depicted) is, in particular, provided, with which liquid W4 can be shifted via conduit 8 between the two receiving units 6, 7. This pump can be driven electrically or manually. Conduit 8 can in particular encompass a valve with which an unintentional flow of liquid W4 from second receiving unit 7 to first receiving unit 6 is prevented.

The result of embodying the counterweight as a liquid that can be shifted steplessly between the two receiving units 6, 7 is that the counter-torque for equilibrating microscope W1 and/or auxiliary apparatuses W2, W3 can be accurately adjusted in simple fashion, so that microscope W1 (and, if applicable, auxiliary apparatuses W2, W3) remain in the desired position that is established.

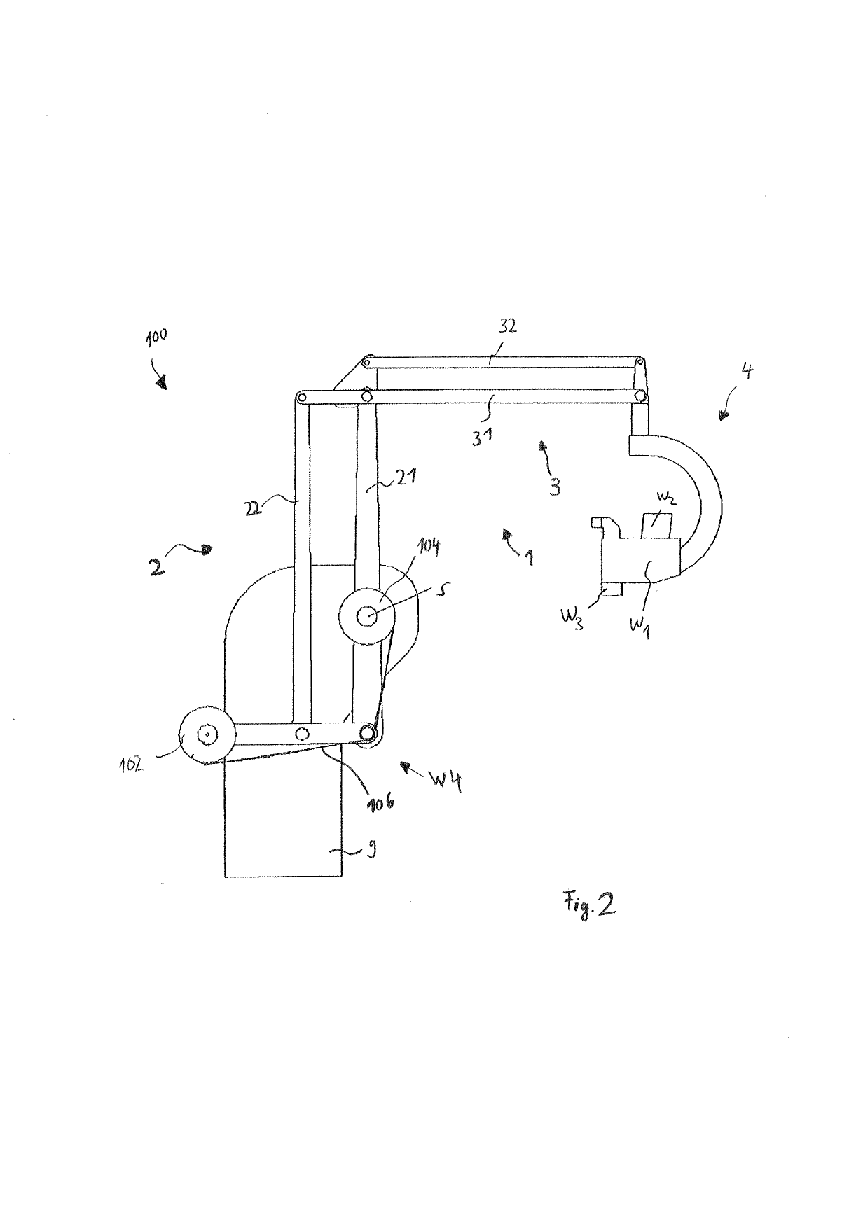

FIG. 2 is a schematic depiction of a stand 100 in accordance with a second embodiment. In contrast to the first embodiment shown in FIG. 1, in the second embodiment of stand 100 two reels 102, 104 are provided as receiving units instead of containers 6, 7; first reel 102 is again arranged as the longest possible lever with respect to axis S, and second reel 104 is arranged in such a way that its center point coincides with axis S. In this second embodiment a spoolable element 106, for example a belt, a cable, and/or a chain, is provided as counterweight W4. A first end region of spoolable element 106 is mounted on first reel 102, and a second end region, located oppositely from the first end region, of spoolable element 106 is mounted on second reel 104. By means of a corresponding rotation of reels 102, 104, spoolable element 106 is unwound from the one reel 102, 104 and wound into the other reel 102, 104. The differing lever arms of reels 102, 104 with respect to axis S thus causes the torque about axis S generated by the spoolable element 106 to change. Because the center axis of second reel 104 is coincident with axis S, the mass of spoolable element 106 that is wound onto second reel 104 generates no torque about axis S; torque is generated only by that mass which is wound onto first reel 102, or by that proportion of spoolable element 106 which is arranged between the two reels 102, 104.

The result achieved with this embodiment as well is that thanks to the winding of a portion of spoolable element 106 from the one reel 102, 104 onto the other reel 102, 104, the counter-torque can be modified, and stand 100 thus equilibrated, in simple fashion

In an alternative embodiment of the invention, more than two reels 102, 104 can also be provided for winding up spoolable element 106. In addition, alternatively, second reel 102 can be arranged at a distance from axis S, so that the proportion of spoolable element 106 wound onto it also generates a torque with respect to axis S.

### PARTS LIST

1 Carrier unit

2, 3 Parallel member

4 Holding unit

6, 7 Container

8 Conduit

9 Stand foot

10, 100 Stand

21, 22, 23, 31, 32 Carrier

102, 104 Reel

106 Spoolable element

S Axis

W1 Microscope

W2, W3 Auxiliary apparatus

W4 Counterweight

What is claimed is:

1. A stand, for holding at least one medical device, the stand comprising:
a stand foot (9);
a carrier unit (1) connected to the stand foot (9) rotatably about an axis (S), the medical device (W1, W2, W3) being mountable on the carrier unit (1), a counterweight (W4) arranged to compensate for torque about the axis (S) produced by the at least one medical device (W1, W2, W3) and the carrier unit (1);
a first receiving unit (6, 102) arranged at a first location for receiving a proportion of the counterweight (W4); and
a second receiving unit (7, 104) arranged at a second location for receiving another proportion of the counterweight (W4);
wherein, upon an increase in the torque about the axis (S) produced by the medical device (W1, W2, W3) and the carrier unit (1), in order to compensate for the torque, the proportion of the counterweight (W4) received by the first receiving unit (6, 102) is increasable by a torque-increase compensation value, and the proportion of the counterweight (W4) received by the second receiving unit (7, 104) is reducible by the torque-increase compensation value.

2. The stand (10, 100) according to claim 1, wherein at least a portion of the counterweight (W4) is conveyable between the first receiving unit (6, 102) and the second receiving unit (7, 104).

3. The stand (10, 100) according to claim 1, wherein upon a decrease in the torque about the axis (S) produced by the medical device (W1, W2, W3) and the carrier unit (1), in order to compensate for the torque, that proportion of the counterweight (W4) which is received in the second receiving unit (7, 104) is increasable by a torque-decrease compensation value, and that proportion of the counterweight (W4) which is received by the first receiving unit (6, 102) is reducible by the torque-decrease compensation value.

4. The stand (10, 100) according to claim 1, wherein a distribution of the counterweight (W4) between the first receiving unit (6, 102) and the second receiving unit (7, 104) is steplessly modifiable.

5. The stand (10, 100) according to claim 1, wherein at least one of the first receiving unit (6, 102) and the second receiving unit (7, 104) is configured such that the entire counterweight (W4) is receivable thereby.

6. The stand (10, 100) according to claim 1, wherein the distance of the first location from the axis (S) and the distance of the second location from the axis (S) are different.

7. The stand (10, 100) according to claim 1, wherein the axis (S) extends through a center point of the second receiving unit (7, 104).

8. The stand (10) according to claim 1, wherein the counterweight (W4) is a liquid.

9. The stand (10) according to claim 8, wherein the first receiving unit (6) encompasses a first container for receiving at least a portion of the liquid (W4), and the second receiving unit (7) encompasses a second container for receiving at least a portion of the liquid (W4); the first container (6) and the second container (7) are interconnected via a conduit (8) for the passage of liquid (W4); and in order to compensate for the torque produced about the axis (S) by the medical device (W1, W2, W3) and the carrier unit (1), the liquid (W4) is transportable via the conduit (8) between the two containers (6, 7).

10. The stand (10) according to claim 9, wherein at least one pump is provided for delivering liquid (W4) from the first container (6) to the second container (7) and from the second container (7) to the first container (6).

11. The stand (100) according to claim 1, wherein the counterweight (W4) is a spoolable element (106).

12. The stand (100) according to claim 11, wherein the spoolable element is a chain, belt, or cable.

13. The stand (100) according to claim 11, wherein the first receiving unit (102) includes a first reel and the second receiving unit (104) includes a second reel;
and wherein a first end region of the spoolable element (106) is mounted on the first reel and a second end region of the spoolable element (106), located oppositely from the first end region, is mounted on the second reel; and in order to compensate for the torque about the axis (S) produced by the medical device (W1, W2, W3) and the carrier unit (1), a portion of the spoolable element (106) is unwound from the one of the first and second reels and wound onto the other of the first and second reels.

14. The stand (100) according to claim 13, further comprising at least one electric motor arranged for rotating at least one of the first reel and the second reel in order to respectively wind on and unwind the spoolable element.

15. The stand (10, 100) according to claim 1, wherein the sum of the mass of the counterweight (W4) received by the first receiving unit (6, 102) and the mass of the counterweight (W4) received by the second receiving unit (7, 104) is constant.

16. An apparatus comprising:
a stand including:
a stand foot (9);
a carrier unit (1) connected to the stand foot (9) rotatably about an axis (S);
a counterweight (W4) arranged to compensate for torque about the axis (S) produced by the at least one medical device (W1, W2, W3) and the carrier unit (1);
a first receiving unit (6, 102) arranged at a first location for receiving a proportion of the counterweight (W4); and
a second receiving unit (7, 104) arranged at a second location for receiving another proportion of the counterweight (W4);
wherein, upon an increase in the torque about the axis (S) produced by the medical device (W1, W2, W3) and the carrier unit (1), in order to compensate for the torque, the proportion of the counterweight (W4) received by the first receiving unit (6, 102) is increasable by a torque-increase compensation value, and the proportion of the counterweight (W4) received by the second receiving unit (7, 104) is reducible by the torque-increase compensation value; and
at least one medical device (W1, W2, W3) mounted on the carrier unit (1).

17. The apparatus according to claim 16, wherein the at least one medical device includes a microscope.
